(19) United States
(12) Patent Application Publication
(10) Pub. No.: US 2007/0008333 A1
(43) Pub. Date: Jan. 11, 2007

(54) Texture filter using parallel processing to improve multiple mode filter performance in a computer graphics environment

(75) Inventor: Jianming Xu, San Jose, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc.

(21) Appl. No.: 11/176,911

(22) Filed: Jul. 7, 2005

(51) Int. Cl. G09G 5/00

(52) U.S. Cl. 345/582

(57) ABSTRACT

Provided are methods, systems and graphics processing apparatus, for improving graphics system performance using a parallel processing texture filter for trilinear filtering. The texture filter unit includes multiple filter units, which may be utilized separately for bilinear and free-trilinear filtering or together to perform true trilinear filtering.

### TECHNICAL FIELD

The present disclosure is generally related to texture filters, and, more particularly, is related to texture filters using parallel processing to improve filter performance on multiple mode texture data.

### BACKGROUND

As is known, computer graphics processing systems process large amounts of data, including texture data, among others. A texture is a digital image, often rectangular, having a (U, V) coordinate space. The digital image can also be expressed in three-dimensions having a (U, V, S) coordinate space. The smallest addressable unit of a texture is a texel, which is assigned a specific (U, V) coordinate based on its location. texture mapping is a well-known technique of projecting a texture onto a surface in a graphics system. Typical applications of the technique involve reading texture data (texels) of a two-dimensional texture that represents a digitized image, and mapping the texture data onto a surface that is defined in three-dimensional space. The surface, when rendered and projected onto a two-dimensional display, is imbued with greater realism as it appears to contain the surface characteristics defined in the texture map. In a texture mapping operation, a texture is mapped to the surface of a graphical model as the model is rendered to create a destination image. In the destination image, pixels are located at specific coordinates in the (X, Y) coordinate system in two-dimensional space or the (X, Y, Z) coordinate system in three-dimensional space.

Many applications, such as video games, utilize three-dimensional surfaces having widely varying dimensions and shapes. Some surfaces, representing objects that appear to be far away from the viewer, may be relatively small, while other surfaces, representing objects that appear to be closer, may be large. In order to allocate resources efficiently and avoid wasting valuable processor time, it is beneficial to vary the amount of detail presented for on-screen objects according to their relative apparent proximity to the viewer. Smaller, far-away objects may be rendered in less detail than larger, close-up objects, without unduly compromising the user experience.

Additionally, rendering three-dimensional images creates several problems such as the image quality produced by applying textures to primitives such as triangles and polygons. When the discrete image is generated by sampling an abstract image, visual artifacts are often included in the discrete image. Often the images need to be filtered to remove visual artifacts such as banding or aliasing effects. Additional artifacts such as banding are also caused by morphing or transforming images between various levels of detail in an image.

Multum in parvo mapping (MIP-mapping) is a technique used in graphics applications to alleviate problems such as those described above and to provide varying levels of detail in texture mapping. It is based on a scheme wherein several levels of detail are made available for a particular texture map. One particular type of MIP-mapping scheme is referred to as “trilinear texture filtering” because the value for a particular texel at a particular resolution level is interpolated on three values: the X-coordinate, U; the Y-coordinate, V; and a linear description of the level of detail, D. Those skilled in the art will recognize that a variety of different filtering methods may be used. By using a texture map version having an appropriate level of detail for the parameters of the rendered image, MIP-map schemes tend to improve the image quality by reducing the effects of the visual artifacts, and without unduly increasing the computations and resources needed.

Prior art approaches to trilinear texture filtering typically store several versions of a particular texture map, at varying levels of detail. Usually, these levels are defined by powers of two, for example, a 2×2 square containing four texels corresponding to one texel at the next higher level of detail is filtered (averaged) to produce the next upper level texel. In the limit, the entire texture map may be reduced to one texel at the lowest level of detail.

In connection with a texture mapping operation, a desired level of detail is selected. As an on-screen object moves “closer to” or “farther away from” the user's point of view, this requires a change in the selected level. In other words, an object's apparent distance from the user may change from frame to frame, and where such changes cause a different stored texture map version to be used, a visible and undesirable discontinuity in resolution may occur.

Although, some MIP-map engines employ interpolation to provide intermediate levels of detail between stored texture map versions, the existing techniques generally employ specialized hardware and/or multiple filter passes to perform the trilinear filtering. Thus, a heretofore-unaddressed need exists in the industry to address the aforementioned deficiencies and inadequacies.

### SUMMARY

Embodiments of the present disclosure may be viewed as providing a graphics processing system, comprising: a texture filter unit that receives texture data; a first texture filter within the texture filter unit that receives a first set of texture data and generates a first weight value; a second texture filter within the texture filter unit that receives a second set of texture data and generates a second weight value; and an accumulator configured to combine the first weight value with the second weight value and to generate a composite weight value.

Briefly described, in architecture, one embodiment, among others, can be implemented as a method for processing texture data in a graphics processor, comprising the steps of: receiving, into a texture filter unit, texture data corresponding to a plurality of pixels; dividing the texture filter unit into a first texture filter and a second texture filter, the first texture filter and the second texture filter each receiving a portion of the texture data; generating a first weight value from the first texture filter and a second weight value from the second texture filter; accumulating the first weight value and the second weight value; and generating a composite weight value.

Another embodiment of the present disclosure can be viewed as providing a method for performing trilinear filtering is a single pass through a texture filter unit, comprising: receiving texture data corresponding to a pixel; interpolating a portion of the texture data in a first texture filter; interpolating a portion of the texture data in a second texture filter; accumulating a first weight value from the first texture filter and a second weight from the second texture filter; and generating a composite weight value.

An embodiment of the present disclosure can also be viewed as providing a graphics processing apparatus comprising a texture filter unit, the apparatus comprising: a first texture filter configured to receive a first set of texture data and to produce a first weight value; a second texture filter configured to receive a second set of texture data and to generate a second weight value; and an accumulator, configured to receive the first weight value and the second weight value and produce a composite weight value.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a simplified block diagram of a computer system 100.

FIG. 2 is a block diagram illustrating an exemplary system 200 for performing texture filtering operations of the present disclosure.

FIG. 3 illustrates certain basic components of an embodiment of the disclosure.

FIG. 4 is a block diagram illustrating an exemplary arrangement of logical components configured to process texture data using the techniques disclosed herein.

FIG. 5 is a block diagram illustrating an exemplary configuration of a texture filter unit and accumulator as disclosed herein.

FIG. 6 is a block diagram illustrating an exemplary configuration of texture filter 1, as referenced in FIG. 5 above.

FIG. 7 is a block diagram illustrating an exemplary configuration of texture filter 2, as referenced in FIG. 5 above.

FIG. 8 is an exemplary diagram illustrating the concept of box filtering, as disclosed herein.

FIGS. 9a-9b are exemplary diagrams illustrating the concept of bilinear filtering.

FIG. 10 is an exemplary diagram illustrating a MIP-map as used for texture mapping in the disclosure herein.

FIG. 11 is a block diagram illustrating exemplary components of an LRP utilized in some embodiments.

FIG. 12 is a block diagram illustrating the interoperation of the MUX, shifter, and adder of the LRP referenced in FIG. 11.

FIG. 13 is a block diagram illustrating an operation of an exemplary accumulator, as disclosed herein.

FIG. 14 is a table illustrating exemplary accumulator weights used in the different filter modes of embodiments as disclosed herein.

FIG. 15 is a block diagram illustrating a method as disclosed herein.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed therein. On the contrary, the intent is to cover all alternatives, modifications and equivalents included within the spirit and scope of the disclosure as defined by the appended claims.

As will be described further herein, there are several locations in a graphics system where features or aspects of the disclosure may be implemented. Likewise, it will be appreciated from the description herein that there are systems and environments in fields other than computer graphics where the concepts of the disclosure may be employed as well.

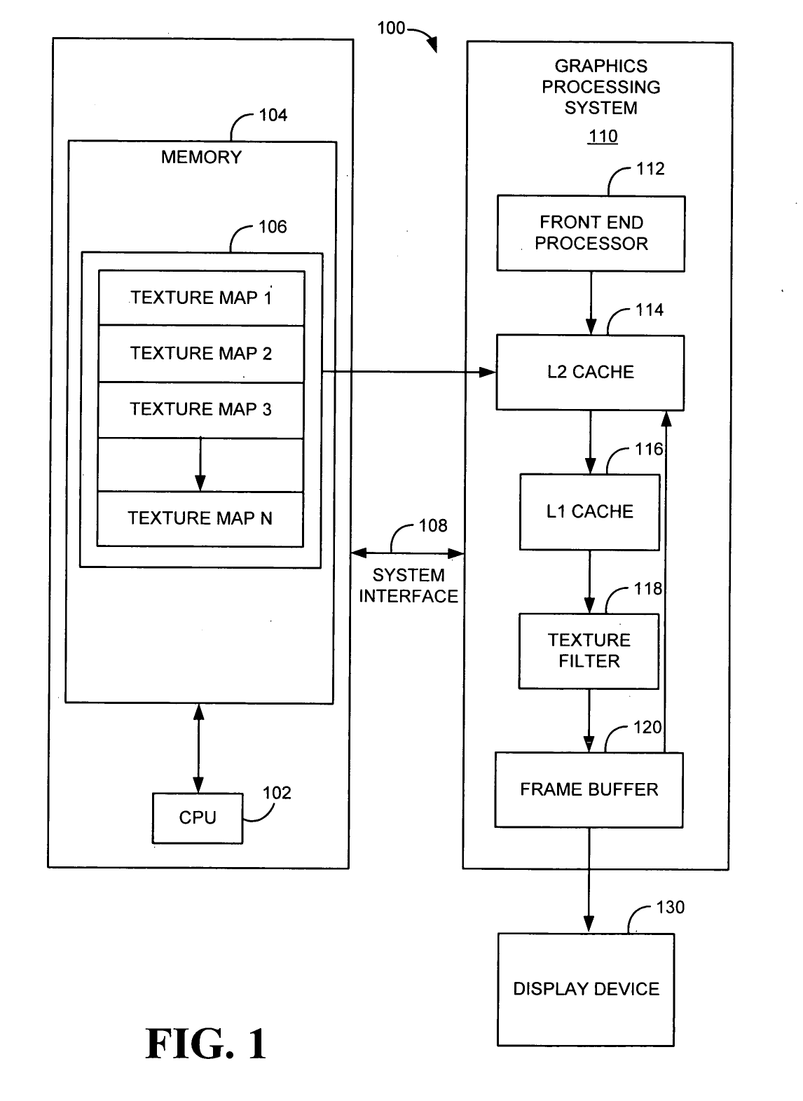

Reference is made to FIG. 1, which illustrates a simplified block diagram of a computer system 100. The computer system 100 includes a CPU 102, a memory 104 and a graphics processing system 110. The CPU 102 performs various functions, including determining information, such as a viewpoint location, which allows for the generation of graphic displays. The memory 104 stores a variety of data, including graphic display data such as multiple texture maps 106. The memory 104 can be system memory, video memory, or a combination thereof. The graphics processing system 110 generates display data for a display device 130, such as, for example, a monitor.

The CPU 102 provides requests to the graphics processing system 110 over a system interface 108, including requests to process and display graphics information. Graphics requests from the CPU 102 are received by the graphics processing system 110 and provided to a front end processor 112, which generates a pixel stream containing pixel coordinates concomitant to the display device 130.

Information relating to the pixel coordinates generated by the front end processor 112 is provided to a texture filter 118. The texture filter 118 filters the information and generates texture data for each pixel. The texture data is a component of the final color data that is sent to a frame buffer 120, which is used to generate a display on a display device 130.

The graphics processing system 110 includes multiple caches 114, 116 to store portions of texture maps 106 used during graphics processing. The texture maps 106 store texture information as individual texture elements known as texels, which are used during graphics processing to define color data displayed at pixel coordinates. The texture data flows from the memory 104 to the caches 114, 116.

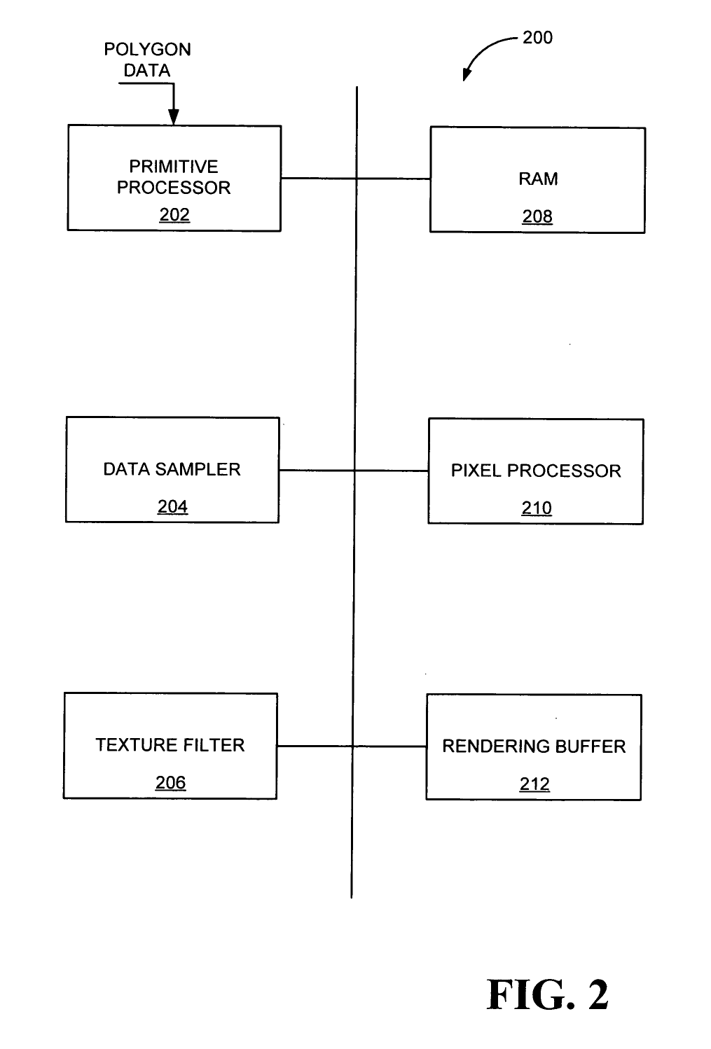

Reference is briefly made to FIG. 2, which is a block diagram illustrating an exemplary system 200 for performing texture filtering operations of the present disclosure. The system 200 is typically implemented in a graphics processing system within a computer or similar processing device. The system 200 includes a primitive processor 202, a data sampler 204, a texture filter 206, RAM 208 for storing textures, a pixel processor 210 and a rendering buffer 212.

The primitive processor 202, which may be a triangle processor, typically receives the three-dimensional geometry elements (e.g., triangles or other graphic primitives) and processes the data describing the size, shape, position, and other relative characteristics of the graphics primitives.

The data sampler 204 selects a finite set of values from the polygon data received by the primitive processor 202. The texture filter 206 performs one of the filtering techniques (e.g., bilinear filtering, trilinear filtering, box filtering, and/or a combination thereof) to calculate the color value (or other attribute) of a new texel, which is then assigned to a particular pixel. The texture filter 206 may generate the filtered textured pixel values based on data received from the RAM 208.

The pixel processor 210 performs rendering operations and the rendering buffer 212 stores images, which may be displayed in a display device or used to render another image.

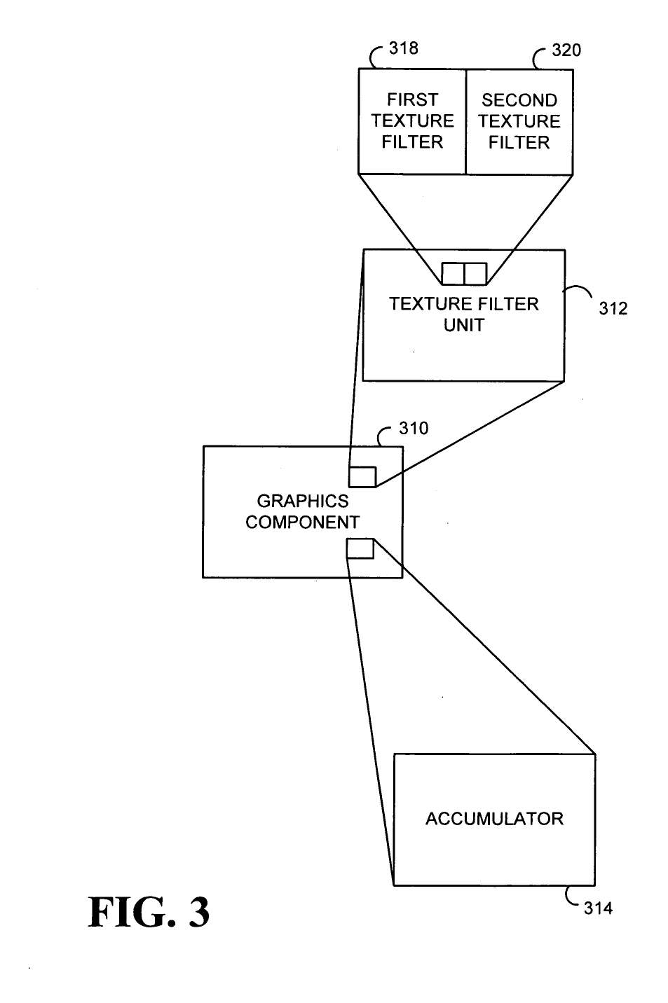

Reference is made briefly to FIG. 3, which illustrates certain basic components of an embodiment of the disclosure. FIG. 3 includes a component labeled “Graphics Component” 310, which may designate or represent hardware components in a graphics pipeline. Within this component, logic may be provided for a texture filter unit 312, which processes texture data to produce a weighted color value, also referred to as a weight value, for modifying the pixel color. As discussed below, the texture filter unit 312 may be further divided into multiple texture filters including, for example, a first texture filter 318 and a second texture filter 320. Likewise, an accumulator 314 may be provided for accumulating the results of the individual texture filters to produce a composite weighted color value.

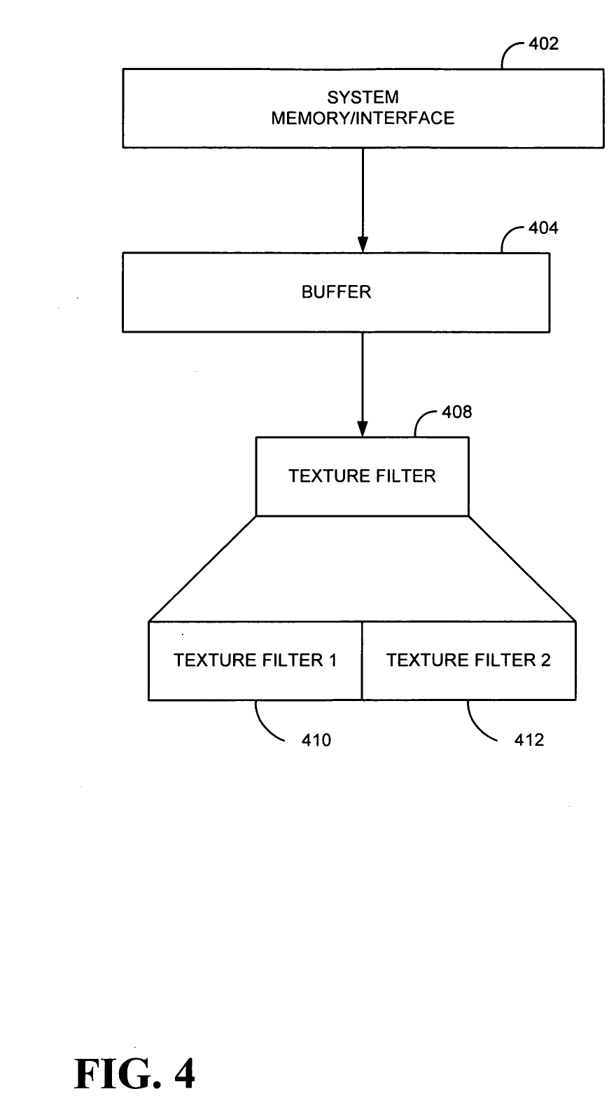

Reference is now made to FIG. 4, which is a block diagram illustrating an exemplary arrangement of logical components configured to process texture data using the techniques disclosed herein. The system memory and memory interface 402 serve to provide the texture filter system with the texture data that is stored in texture maps. This texture data, when requested, may be provided in the form of texture address data to the buffer 404. Although the texture address data may be in the form of physical address data, some embodiments utilize logical address data, which will ultimately be resolved into physical address data. Although not shown, alternative embodiments may provide that the buffer 404 constitutes one or more data caches for storing the texture data. In the case where the buffer 404 constitutes multiple data caches, the texture data may be received and stored by any one or any combination of the caches. The texture data is stored in the buffer 404 for subsequent processing by the texture filter 408. The texture filter 408 may be divided into individual texture filters 410 and 412, such that the texture filters 410 and 412 may be capable of performing the filtering operations independently or in combination.

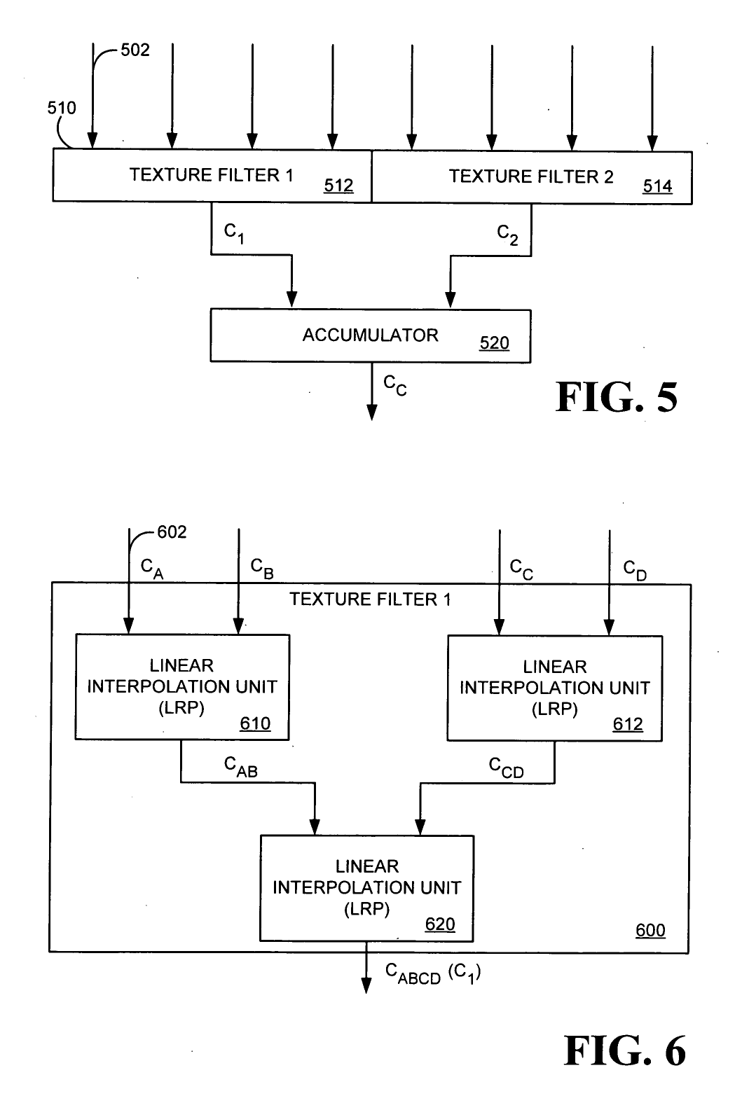

Reference is now made to FIG. 5, which is a block diagram illustrating an exemplary configuration of a texture filter unit and accumulator as disclosed herein. The texture filter unit 510 includes a first texture filter 512 and a second texture filter 514. Each of the texture filters 512, 514 is configured to receive multiple texture samples 502. In some cases, the first texture filter 512 operates independently of the second texture filter 514, to process multiple samples of texture data 502 and generate a weighted color value C₁. The texture filter in this case would be performing bilinear filtering, as discussed below in reference to FIGS. 9a-9b.

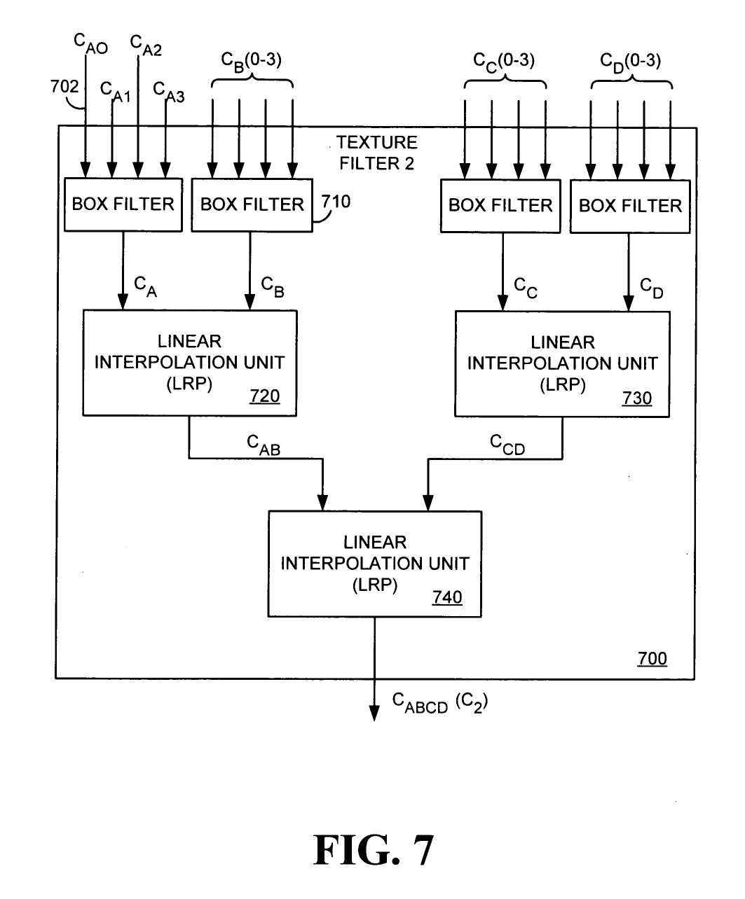

Similarly, the second texture filter 514 receives four samples of texture data and generates a weighted color value C₂. As discussed below in reference to FIG. 7, the second texture filter 514, when operating independently of the first texture filter 512, may be performing bilinear filtering or free-trilinear filtering.

Alternatively, the first texture filter 512 and the second texture filter 514 may operate in parallel to process eight texture data samples 502 for a specific pixel. Regardless of whether the first and second texture filters 512, 514 are operating independently or together, the C₁ and C₂ weighted color values are received by an accumulator 520. When the first and second texture filters 512, 514 are operating independently, the accumulator 520 performs like a multiplexer, such that C_{c} is the weighted color value from either the first texture filter 512 or the second texture filter 514. Alternatively, when the first and second texture filters 512, 514 are operating together, the accumulator 520 generates a composite weighted color value C_{c} that represents a combination of the two weighted color values C₁ and C₂. The accumulator 520, may also combine weighted color values generated in different cycles from the second texture filter 514 to perform trilinear filtering serially.

Reference is now made to FIG. 6, which is a block diagram illustrating an exemplary configuration of texture filter 1, as referenced in FIG. 5 above. As discussed above, texture filter 1 600, also referred to as the first texture filter, receives multiple texture samples 602 associated with the texels closest to the pixel and generates a weighted color value C₁. Filter 1 600, when operating independently of texture filter 2, performs a bilinear interpolation, which requires the texture samples 602 of the four texels closest to the pixel. Generally, bilinear interpolation involves receiving, for example, the four known weighted color values that are closest to the point that is being resolved. A linear interpolation is performed with respect to one dimension on each of the two pairs of the four known weighted color values to determine a pair of intermediate composite weight values. For example, the linear interpolation on the two pairs can be performed with respect to the U dimension. A second linear interpolation is performed with respect to a second dimension on the intermediate composite weight values to determine a composite weight value. For example, the linear interpolation on the intermediate composite weight values can be performed with respect to the V dimension. The texture samples 602 include coordinate location values U, V, and, optionally, D, and weighted color values C_{A}, C_{B}, C_{C}, and C_{D}. The first texture filter 600 includes three linear interpolation units (LRP's) 610, 612 and 620, which perform a linear interpolations in, for example, the U, and/or D dimensions.

Two of the LRP's 610, 612 are configured to each receive two of the texture samples 602. Typically, the texture samples 602 will be paired such that they share a common U or V coordinate, for example, the LRP's 610 and 612 will each perform a linear interpolation on the respective pairs of texture samples 602. For example, LRP 610 performs a linear interpolation on the texture samples 602 having weighted color values C_{A} and C_{B} to generate a weighted color value C_{AB}. Similarly, LRP 612 performs a linear interpolation on the texture samples 602 having weighted color values C_{C} and C_{D} to generate a weighted color value C_{CD}. Both C_{AB} and C_{CD} are the result of a linear interpolation in the same dimension. For example, where C_{AB} is a linear interpolation of C_{A} and C_{B} along the U axis, C_{CD} will be a linear interpolation of C_{C} and C_{D} along the U axis also.

The third LRP 620 is configured to receive the C_{AB} and C_{CD} weighted color values and perform a linear interpolation in, for example, the V dimension. The LRP 620 generates a weighted color value C_{ABCD}, which constitutes the output from the first texture filter 600. The C_{ABCD} weighted color value, which is also referred to as C₁, represents the linear interpolation of the four texture samples 602 in both the U and V dimensions.

Reference is now made to FIG. 7, which is a block diagram illustrating an exemplary configuration of texture filter 2, as referenced in FIG. 5 above. As discussed above, texture filter 2 700, also referred to as the second texture filter, receives multiple texture samples 702 corresponding to the texels closest to the pixel and generates a weighted color value C₂. Filter 2 700, when operating independently of filter 1, performs either a bilinear interpolation or a free-trilinear interpolation. Which of the bilinear or free-trilinear interpolation is performed is determined by the format of the texture data received. For example, where the multiple texture samples 702 do not include multiple samples having more than a single value in a third dimension, for example the D dimension, then each box filter 710 may only receive a single texture sample, C_{A0} for example. The resulting weighted color value will necessarily be equal to the input in this circumstance based on a closest to the pixel technique. Alternatively, where the multiple texture samples 702 have more than a single value in a third dimension, then each box filter 710 will necessarily be presented with more than one texture sample and the sample closest to the pixel will be selected.

Texture filter 2 700, as illustrated, includes four box filters 710 and three LRP's 720, 730, and 740. One of ordinary skill in the art will appreciate that alternative embodiments can utilize other quantities of box filters 710, including, but not limited to, 2^{X} box filters where X is a positive integer. The box filters 710 are configured to receive multiple texture samples 702. Each box filter 710 receives, for example, the texture samples 702 corresponding to texture data proximate to the pixel in the U, V, and, in some cases, D dimensions, where D is a level of detail value used in a MIP-map texture mapping technique. In the case where the second texture filter 700 performs a bilinear interpolation, the box filters 710 are effectively pass-through filters and perform no data manipulation. In this circumstance, the LRP's 720, 730, and 740 perform the bilinear filtering in the same manner as the LRP's of texture filter 1.

Where texture filter 2 performs a free-trilinear filtering operation, the texture samples are filtered with respect to one of the three dimensions (U, V, or D) in the box filters 710. The free-trilinear filtering is performed by utilizing the less accurate filtering of a box filter with respect to a first dimension and performing the bilinear interpolation, as previously discussed, with respect to second and third dimensions. The box filtering is less accurate than filtering techniques that utilize linear interpolation methods because a box filter 710 merely generates an output corresponding an equally weighted average of the four closest texels. The box filter 710 uses, for example four texels in a D=N texture surface to generate one texel in a D=N+1 texture surface. Assuming the four neighbor texels in the D=N texture surface are T0, T1, T2 and T3, the corresponding texel in the D=N+1 texture surface are calculated as: T′=(T0+T1+T2+T3)/4. In some embodiments, when using the box filter 710 for performing free-trilinear filtering, texture filter 2 only supports fixed format numbers, unlike texture filter 1, which supports both floating point and fixed format numbers. One of ordinary skill in the art will appreciate that a box filter capable of supporting floating point and fixed format numbers is contemplated within the scope and spirit of this disclosure. The weighted color values C_{A}, C_{B}, C_{C}, and C_{D} generated from the box filters 710 are received by the LRP's 720, 730 for interpolation along another of the dimensions. The LRP's 720, 730 generate weighted color values C_{AB} and C_{CD}, which are then received by LRP 740 for interpolation along the other of the dimensions. LRP 740 generates C_{ABCD}, also referred to as C₂, which is a weighted color value estimate based on texture samples in three dimensions.

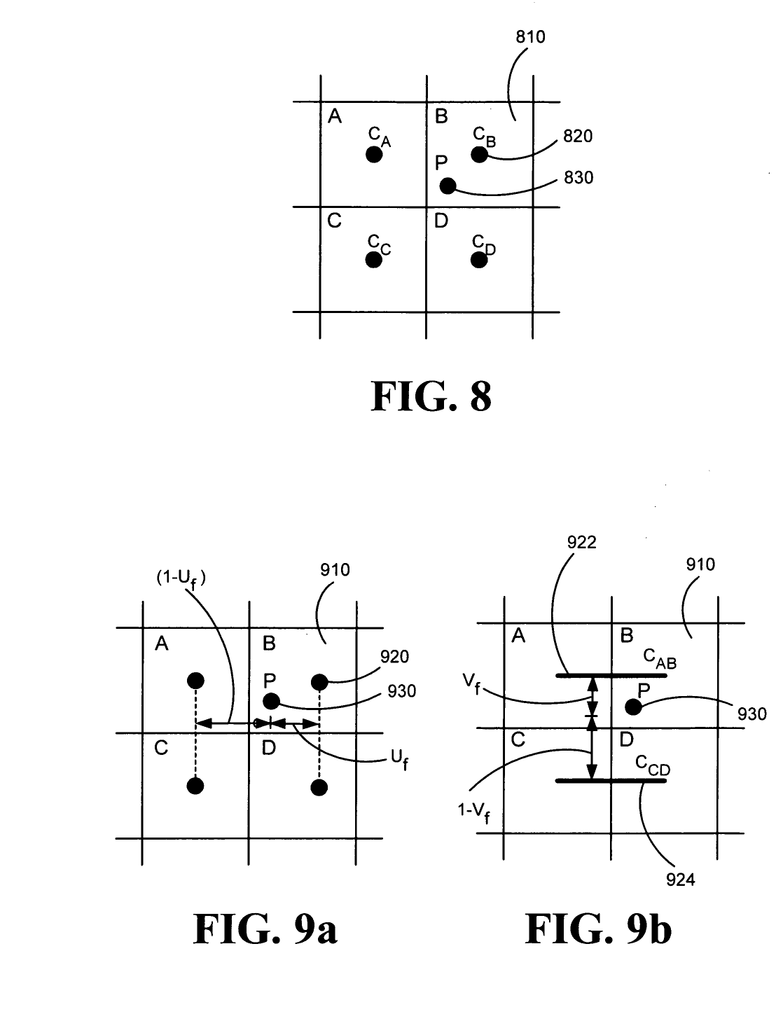

Reference is now made to FIG. 8, which is an exemplary diagram illustrating the concept of box filtering, as disclosed herein. Shown is a 2×2 block of the four texels 810, labeled A, B, C, and D, that constitute the four closest texture samples 820 to a pixel 830. The texture samples 820 each have a color value C_{A}, C_{B}, C_{C}, and C_{D}, which corresponds to a respective texel. In this example, the weighted color value generated by a box filter is the equally weighted average of the color values C_{A}, C_{B}, C_{C}, and C_{D}.

Reference is now made to FIGS. 9a-9b, which are exemplary diagrams illustrating the concept of bilinear filtering. First, looking at FIG. 9a, shown is a 2×2 block of four texels 910, labeled A, B, C, and D, which constitute the four texture samples 920 closest to a pixel 930. The texture samples 920 have weighted color values C_{A}, C_{B}, C_{C}, and C_{D}, each corresponding to a respective texel 910. Assuming that the width of each texel 910 is normalized to equal 1, and U_{f} represents the distance from the pixel 930 to a line dissecting texels B and D, then (1−U_{f}) will equal the distance from the pixel 930 to a line dissecting texels A and C. From this relationship the formulas for weighted color values interpolated in the U dimension are derived such that:
C_{AB}=C_{A}*(U_{f})+C_{B}*(1−U_{f}) and
C_{CD}=C_{C}*(U_{f})+C_{D}*(1−U_{f}).

Referring now to FIG. 9b, instead of the texture samples illustrated in FIG. 9a, exemplary lines between the above discussed pairs of texels are presented to illustrate the weighted color values lines C_{AB} 922 and C_{CD} 924. Similar to the discussion regarding FIG. 9a, assume that the width of each texel 910 is normalized to equal 1, and V_{f} represents the distance from the pixel 930 to the weighted color value line C_{AB} 922. The distance between the pixel 930 and the weighted color value line C_{CD} 924 is shown to be (1−V_{f}). From this relationship the formula for interpolating the pair of U interpolated weighted color values in the V dimension is derived such that:
C_{ABCD}=C_{CD}*(V_{f})+C_{AB}*(1−V_{f}).
The three equations above each represent the functions of one of the LRP's as discussed regarding FIG. 6.

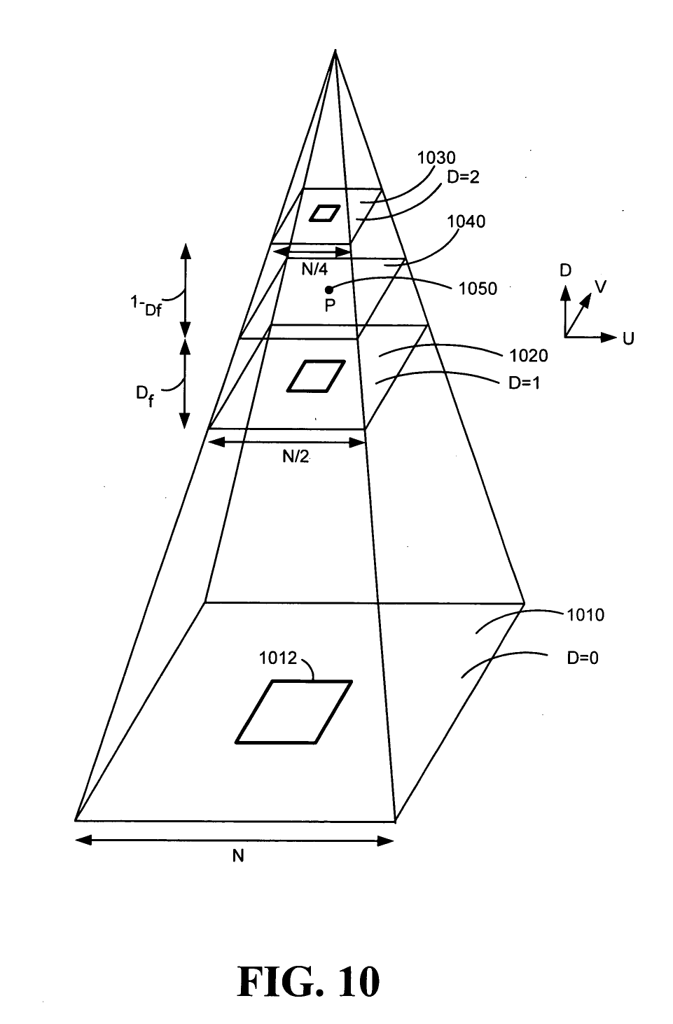

Reference is now made to FIG. 10, which is an exemplary diagram illustrating a MIP-map as used for texture mapping in the disclosure herein. A first level of a texture map 1010 is shown having dimensions N by N texels. A texture image 1012 is stored in the texture map 1010 at full size. The texel or texture data is defined in terms of a first value and a second value. More particularly, the first value can be expressed as U=Uᵢ+U_{f}, where Uᵢ represents an integer component and U_{f} represents a fractional component of the first value. Similarly, the second value can be expressed as V=Vᵢ+V_{f}, where Vᵢ represents an integer component and V_{f} represents a fractional component of the second value. Additional representations or levels 1020, 1030 of the texture image are also shown, having successively lower levels of detail. The lower levels of detail in levels 1020, 1030 result from using fewer texels on each successive level to define the texture data. For example, where the texture data on the texture map at D=0 1010 utilizes 256 (16×16) texels, the D=1 level may use 64 (8×8) texels to define the same texture image. Similarly, the D=2 level may only utilize 16 (4×4) texels to define the same texture image. The reduced number of data points necessarily diminishes the level of detail.

The level of detail represents a scaling factor used in texture mapping, which can be expressed as D=Dᵢ+D_{f}, where Dᵢ represents an integer component and D_{f} represents a fractional component. For example, when the texture image is to be rendered on a relatively small primitive, such as one having a greater perceived distance, less detail is needed than when the texture image is to be rendered on a larger primitive. Each successively lower level of detail can be considered to increase the integer component, such that the texture image 1010 corresponds to a D value of zero. The next level 1020, which has exemplary dimensions of N/2 by N/2 texels, has a corresponding D value equal to one. Accordingly, the highest level 1030 has exemplary dimensions of N/4 by N/4 texels and a D value equal to two. Additionally, as discussed above, each texture sample includes a weighted color value. One of ordinary skill in the art knows or will know that the weighted color value may be a single value or may be a composite value corresponding to multiple independent color values.

An exemplary pixel 1050, is shown between the second and third levels of detail of the texture image. As discussed above in reference to FIGS. 6 and 7, a weighted color value for the pixel 1050 can be determined through the application of several different filtering techniques. For example, a bilinear filter, which utilizes four texture samples, may receive the texture samples associated with the closest U and V coordinates in the texture map 1010. The weighted color values of that bilinear approach, however, fail to account for the level of detail value D.

Application of a free-trilinear filter approach involves use of a box filter in one dimension followed by a bilinear filter for resolving the other two dimensions. By way of example, consider that the texture samples in each level 1010, 1020, and 1030 corresponding to the four closest texture samples in U and V coordinates are presented to the box filters. Referring briefly to FIG. 7, the texture samples 702 C_{A0}-C_{A3} correspond to each of the level of detail color samples of the texture sample associated with texel A, as defined by the U and V coordinates. The result of the box filter 710 will be the texture sample that has the closest level of detail value D to the pixel. Consider, in FIG. 10, that the value of D_{f}, which is the difference between the level of detail of the pixel 1050 and the texture map 1020 having a level of detail D=1, is less than the value of 1−D_{f}, which is the difference between the level of detail of the pixel 1050 and the texture map 1030 having a level of detail D=2. In this case, the box filter 710 will return the value of the corresponding texture sample from the texture map 1020 with a level of detail D=1. Although, unlike bilinear filtering, the free-trilinear filtering accounts for the level of detail, the filtering in the D dimension is relatively coarse and effectively disregards the effect of other levels of detail.

A true trilinear filtering, which will provide interpolation for each of the three dimensions, is performed by utilizing the first and second filters to process eight texture samples in parallel. Continuing with the MIP-map shown in FIG. 10, the first filter, for example, will receive the four closest texture samples in the U and V dimensions located in the texture map 1020 with a level of detail D=1. Similarly, the second filter will receive the four closest texture samples in the U and V dimensions located in the texture map 1030 with a level of detail D=2. The first and second filters will each perform bilinear filtering operations corresponding to the U and V dimensions and will generate weighted color values C₁ and C₂, respectively. The weighted color values from the first and second filters are received by the accumulator, which essentially performs a linear interpolation in the D dimension.

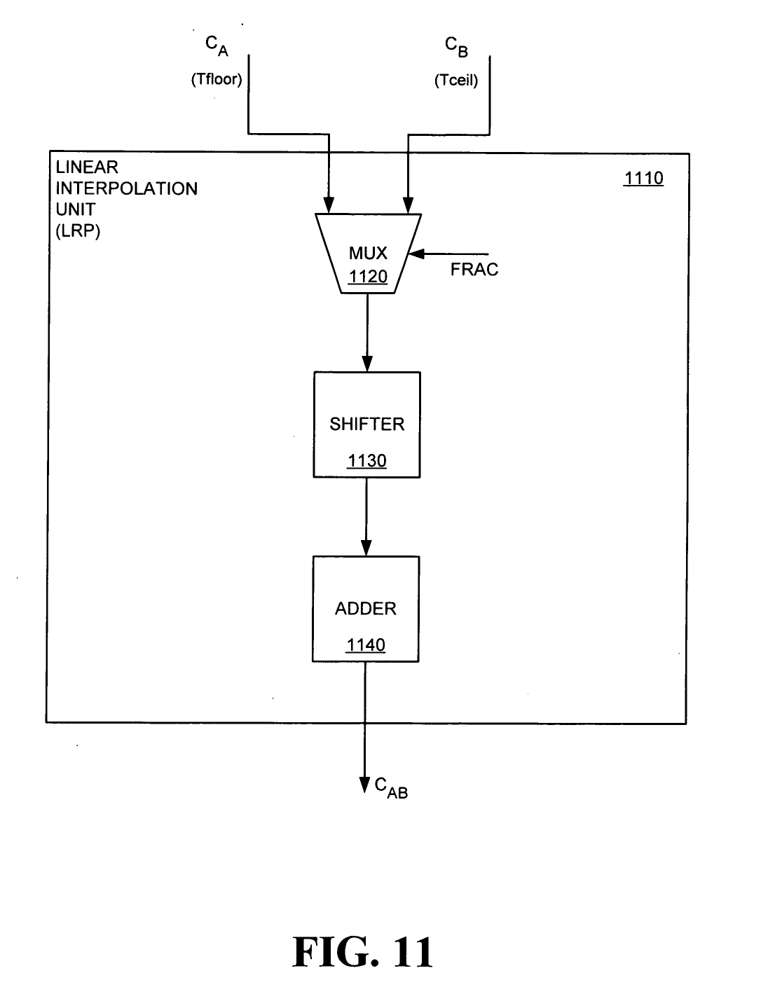

Reference is now made to FIG. 11, which is a block diagram illustrating exemplary components of an LRP utilized in some embodiments. The LRP 1110 of an embodiment is configured to receive weighted color values C_{A} and C_{B} that represent the two closest texture samples in one dimension. The LRP 1110 generates a color weighted value C_{AB} corresponding to the interpolated value of the pixel. The pixel has texture coordinates having multiple dimensions such that each dimension includes an integer component and a fractional component. For example a format with a fixed decimal point having six bits of fractional value will have a fractional range from 000000 to 111111, or 0 to 63. This value can be treated as a fractional value ranging from 0 to 1.

Consider the case where the pixel dimensional value (U) has a format of 13bits for the integer component and 6 bits for the fractional component. The two closest texels are Tfloor and Tceil, which respectively have floor and ceiling values. The integer coordinate value of a texel to the left of the pixel (Ufloor) is determined by
Ufloor=INTEGER(U−0.5)
and the integer coordinate value of a texel to the right of the pixel (Uceil) is determined by
Uceil=Ufloor+1.
The fractional weight value (Wceil) for Uceil is generated by applying a fraction function to the value (U−0.5) such that
Wceil=FRAC=FRACTION(U−0.5)
and the fractional weight value (Wfloor) for Ufloor is determined by the equation
Wfloor=1−Wceil=1−FRAC.
Accordingly, the resulting linear interpolation is determined by the equation
LRP=Tfloor·Wfloor+Tceil·Wceil.
The variables Wfloor and Wceil can each be expressed in terms of FRAC, a variable defining the fractional value above Tfloor and used as the weight factor for Tceil. When the FRAC expressions are substituted in the above equation the linear interpolation equation is:
LRP=Tfloor·(1−FRAC)+Tceil·FRAC.

The expression “1−FRAC” can be shown to equal the inverse of FRAC (FRAC⁻¹) summed with a variable (ULP) that is determined by the format of FRAC. For example, if FRAC is expressed in a 6.0 format, then ULP=1. Alternatively, where FRAC is expressed in a 0.6 format, then ULP=2⁻⁶. For the purposes of this example, we will assume that FRAC is expressed in a 6.0 format, which yields the expression
1−FRAC=FRAC⁻¹+1.
From this relationship, we further derive the linear interpolation to be:
LRP=Tfloor·FRAC⁻¹+Tceil·FRAC+Tfloor·1.

Since the multiplier factors FRAC and FRAC⁻¹ in the LRP equation have an inverse relationship, the LRP unit 1110 can realize a substantial gate savings by using a MUX 1120 and shifter 1130 in front of an adder 1140 instead of two multipliers. In an embodiment, the MUX 1120 is controlled by successive bits in the FRAC value. One of ordinary skill in the art will appreciate that the FRAC⁻¹ value will serve the same purpose. The shifter 1130 is used to shift the selected data corresponding to the specific bit in the FRAC value. Each of the FRAC bits determines which of the Tfloor or Tceil values to select.

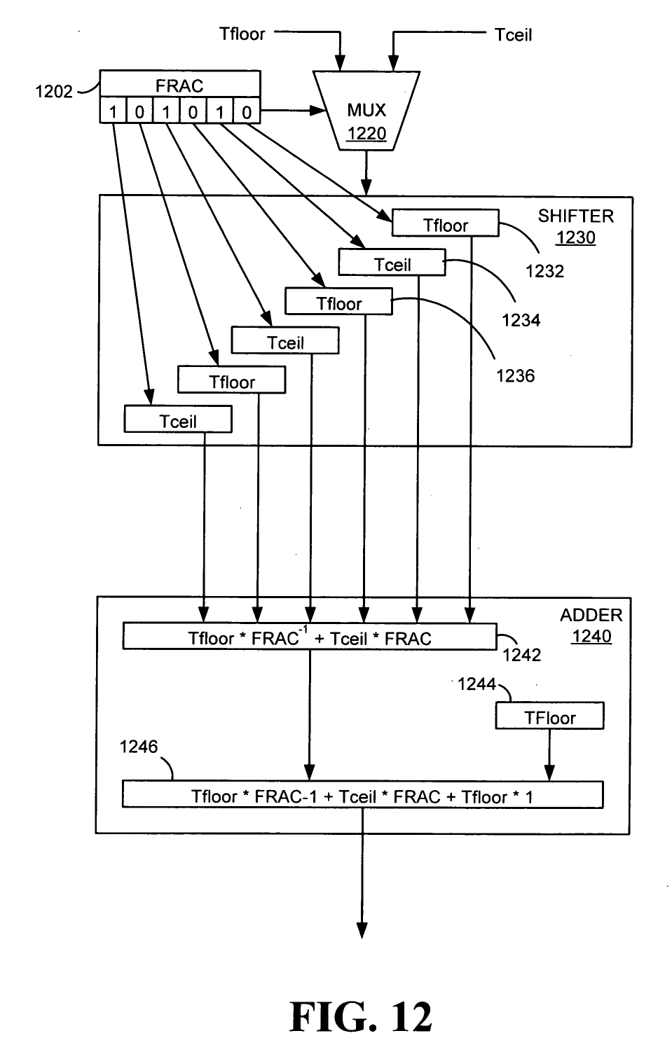

Reference is now made to FIG. 12, which is a block diagram illustrating the interoperation of the MUX, shifter, and adder of the LRP referenced in FIG. 11. Consider an exemplary case where FRAC 1202 is a value represented by the six bits 101010. The first operand for the adder 1240 is generated by the least significant bit of FRAC, which is 0. When the MUX 1220 receives a 0 value, it selects the Tfloor value 1232. In this case, since the selection bit from FRAC is the least significant bit, there is no shifting function and the Tfloor value 1232 is established as one of the operands of the adder 1240. The next bit of FRAC 1202 is 1 so the MUX 1220 selects the Tceil value 1234. The shifter 1230 shifts the Tceil value 1234 left one bit corresponding with the location of the selection bit in FRAC 1202. The shifter Tceil value 1234 is established as the second operand for the adder 1240. Similarly, the next bit in FRAC 1202 is a 0 so the Tfloor value 1236 is selected by the MUX 1220 and shifter left by two bits in the shifter 1230. This Tfloor value 1236 represents the third operand for the adder 1240. Continuing with the remaining bits in FRAC 1202, the six selected and shifted values are operands for the adder 1240 to generate the
Tfloor·FRAC⁻¹+Tceil·FRAC
portion of the LRP value. The remaining operand is Tfloor·ULP or, in this case, an unshifted Tfloor value 1244. The seven operands are summed in the adder 1240 to generate the LRP value per the equation:
LRP =Tfloor·FRAC⁻¹+Tceil·FRAC +Tfloor·1.

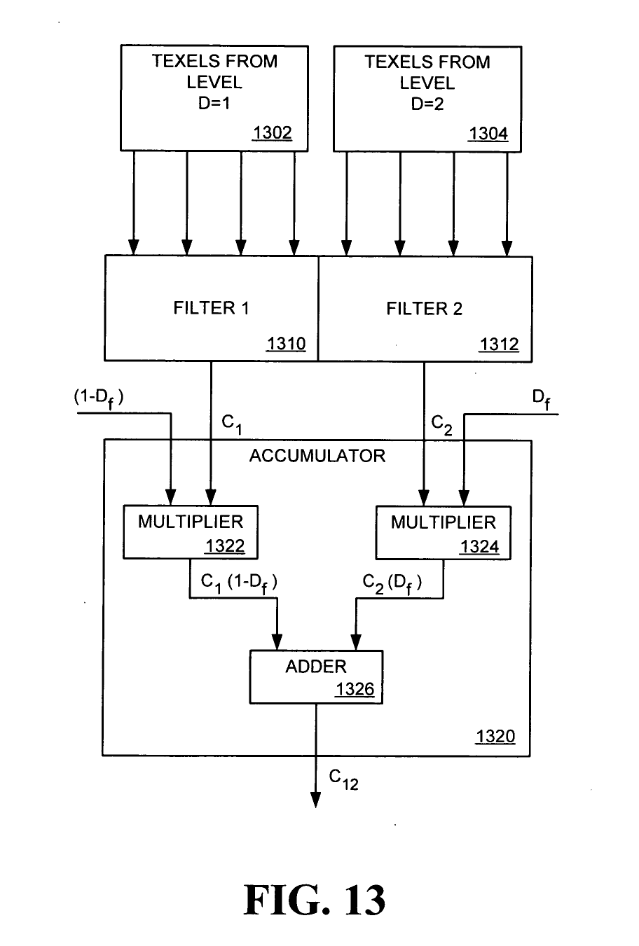

Reference is now made to FIG. 13, which is a block diagram illustrating an operation of an exemplary accumulator, as disclosed herein. Continuing with the true trilinear filtering example above, the texture samples 1302 from the texture map at level D=1 are received by the first filter 1310, also referred to as filter 1, and the texture samples 1304 from the texture map at level D=2 are received by the second filter 1312, also referred to as filter 2. The first and second filters 1310, 1312 generate a weighted color values C₁, C₂, which are received by the accumulator 1320. Within the accumulator 1320, the two weighted color values C₁, C₂ are received by two multipliers 1322, 1324, respectively. The first multiplier 1222 computes the product of the first weighted color value C₁ and the fractional value (1−D_{f}). The second multiplier 1324 computes the product of the second weighted color value C₂ and the fractional value D_{f}. The two products, C₁·(1−D_{f}) and C₂·D_{f} are received by an adder 1326 and a composite weighted color value C₁₂ is generated. The weighted color value C₁₂ represents the texture sample data interpolated in the three dimensions U, V, and D. One of ordinary skill in the art will appreciate that the scope and spirit of this disclosure are not limited to this embodiment. For instance, although the example above performed the interpolation in the U and V dimensions in the filter and the interpolation of the D dimension in the accumulator, one of ordinary skill in the art knows or will know that any of the dimensions could be interpolated in the filters or accumulator.

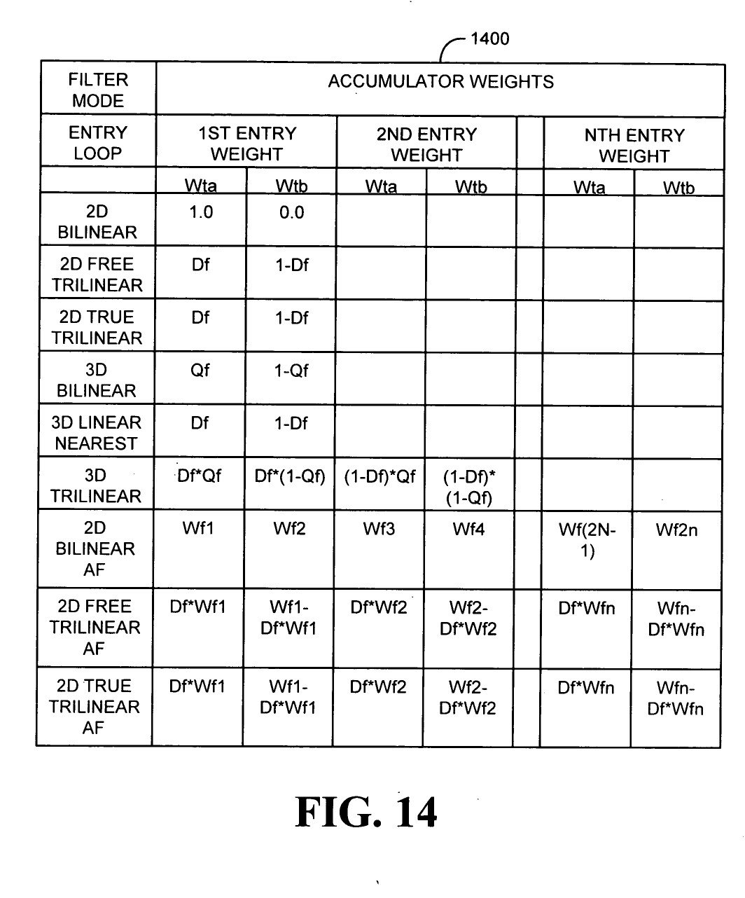

Reference is now made to FIG. 14, which is a table illustrating exemplary accumulator weights used in the different filter modes of embodiments as disclosed herein. The table 1400 lists the formulas for the two weights for the accumulator in the multiple filter modes. The two LRP's in front of the accumulator are the second stages of the bilinear filters as discussed above in reference to FIGS. 6 and 7. The accumulator receives the outputs from the LRP's and completes the requested filter operation using the exemplary values of the table. For example, where the filter operation is two-dimensional bilinear filtering, the accumulator acts as a bypass filter, passing 100% of one incoming filter value and 0% of the other incoming filter value. This example is reflected in the weights of 1.0 and 0.0 in Wta and Wtb columns in the 2D bilinear row. As discussed above in reference to FIG. 10, the value D_{f} is a fractional value of a MIP-map. Similarly, Q_{f} is a fractional value of the texture coordinate in the Q dimension, which refers to the distance between neighboring slices of a three-dimensional texture.

The table 1400 also addresses the case where the requested filter operation requires more than one pass to perform the filtering by providing an entry loop. In these cases, the accumulator weights are recalculated for each filter pass. For example, the row corresponding to a three-dimensional trilinear filtering operation provides additional formulas for calculating the accumulator weights in the second filter pass. Additionally, the accumulator addresses the case where various levels of anisotropic filtering are requested, such as in the last three rows of the table 1400. Anisotropic filtering is a variant of MIP-map filtering that utilizes multiple texture samples taken along a line of anisotropy. The anisotropic filtering operations operation all require multiple filter passes and utilize the weights W_{f}n to calculate the accumulator weights for each of the “n” filter passes. The number of filter passes is the same as the number of anisotropic filter samples per texel.

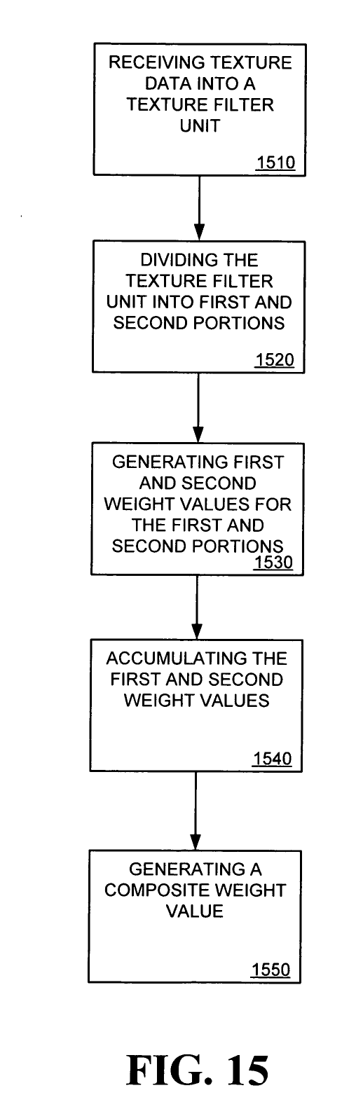

Reference is now made to FIG. 15, which is a block diagram illustrating a method as disclosed herein. Texture data is received into a texture filter unit in block 1510. The texture filter unit is divided into first and second texture filters in block 1520. The first and second texture filters can be utilized to process texture data in a parallel configuration to perform true trilinear filtering. Alternatively, the first and second texture filters can be used independently to perform bilinear or, in the case of the second texture filter, free-trilinear filtering. In each circumstance, the first and second texture filters each generate a color defining weight value in block 1530. The weight values are accumulated from the first and second texture filters in block 1540 by an accumulator. The accumulator generates a composite weighted color value in block 1550 for defining the color. Where the first and second filters operate independently, the composite weighted color value is the same as that filter's weight value. Alternatively, where the first and second texture filters are filtering texture data in parallel for the same pixel, composite weighted color value reflects a combination of two filter's weight values.

The embodiments of the present disclosure can be implemented in hardware, software, firmware, or a combination thereof. In some embodiments, the methods and systems are implemented in software or firmware that is stored in a memory and that is executed by a suitable instruction execution system. If implemented in hardware, as in an alternative embodiment, the methods and systems can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code, which include one or more executable instructions for implementing specific logical functions or steps in the process, and alternate implementations are included within the scope of an embodiment of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

The following is claimed:

1. A graphics processing system, comprising:
a texture filter unit that receives texture data;
a first texture filter within the texture filter unit that receives a first set of texture data and generates a first weight value;
a second texture filter within the texture filter unit that receives a second set of texture data and generates a second weight value; and
an accumulator configured to combine the first weight value with the second weight value and to generate a composite weight value.

2. The system of claim 1, wherein the accumulator is further configured to multiply the first weight value by a first constant and the second weight value by a second constant.

3. The system of claim 2, wherein the first constant and the second constant are related values such that a sum of the first and second constants equals one.

4. The system of claim 3, wherein the first constant equals one such that the composite weight value equals the first weight value.

5. The system of claim 4, wherein the first weight value is generated through a bilinear texture filtering on the first set of texture data.

6. The system of claim 5, wherein the bilinear texture filtering is performed relative to texture location coordinates.

7. The system of claim 3, wherein the second constant equals one such that the composite weight value equals the second weight value.

8. The system of claim 7, wherein the texture filtering comprises multiple filter passes to perform trilinear texture filtering.

9. The system of claim 2, wherein the first constant and the second constant each have a value greater than zero and wherein the texture filtering comprises trilinear texture filtering on a combination of the first set of texture data and the second set of texture data.

10. The system of claim 9, wherein the trilinear texture filtering is performed relative to two texture location coordinates and a level of detail axis.

11. The system of claim 1, wherein the first set of texture data and the second set of texture data each corresponds to N pixels.

12. The system of claim 11, wherein the first texture filter and the second texture filter each comprise N−1 linear interpolators.

13. The system of claim 12, wherein the second texture filter further comprises N box filters, wherein the box filters are configured to preprocess the second set of texture data if free trilinear texture filtering is utilized, and wherein the box filters are pass through filters if either of true trilinear or bilinear texture filtering is utilized.

14. The system of claim 13, wherein N equals 2 raised to the X power, where X comprises a positive integer.

15. The system of claim 1, wherein the first texture filter is configured to receive floating point and fixed number formats.

16. A method for processing texture data in a graphics processor, comprising the steps of:
receiving texture data corresponding to a plurality of pixels;
dividing the texture data into a first portion and a second portion;
generating a first weight value from the first portion and a second weight value from the second portion;
accumulating the first weight value and the second weight value; and
generating a composite weight value.

17. The method of claim 16, generating the composite weight value comprises selecting a value from the group comprising: the first weight value and the second weight value.

18. The method of claim 16, wherein generating the first weight value comprises a performing a two-axis linear interpolation.

19. The method of claim 18, wherein generating the second weight value comprises performing a two-axis linear interpolation.

20. The method of claim 19, wherein generating the composite weight value comprises performing a three-axis linear interpolation.

21. The method of claim 16, wherein generating the first weight value comprises:
performing a first linear interpolation in a first dimension;
performing a second linear interpolation in the first dimension; and
performing a third linear interpolation in a second dimension.

22. The method of claim 16, wherein generating the second weight value comprises:
performing a box filtering in a first dimension;
performing a first linear interpolation in a second dimension;
performing a second linear interpolation in the second dimension; and
performing a third linear interpolation in a third dimension.

23. The method of claim 22, wherein the performing a box filtering comprises processing fixed format data for the linear interpolation units when a three-axis linear interpolation approximation is requested.

24. The method of claim 16, wherein the generating a composite weight value comprises:
generating a first product by multiplying a first constant the first weight value;
generating a second product by multiplying a second constant and the second weight value; and
adding the first product to the second product.

25. A graphics processing apparatus comprising a texture filter unit, the apparatus comprising:
a first texture filter configured to receive a first set of texture data and to produce a first weight value;
a second texture filter configured to receive a second set of texture data and to generate a second weight value; and
an accumulator, configured to receive the first weight value and the second weight value and produce a composite weight value.

26. The graphics processing apparatus of claim 25, wherein the composite weight value equals the first weight value.

27. The graphics processing apparatus of claim 26, wherein the composite weight value corresponds to the first set of texture data.

28. The graphics processing apparatus of claim 27, wherein the composite weight value is a result of a two-axis linear interpolation.

29. The graphics processing apparatus of claim 25, wherein the composite weight value equals the second weight value.

30. The graphics processing apparatus of claim 29, wherein the composite weight value corresponds to the second set of texture data.

31. The graphics processing apparatus of claim 30, wherein the composite weight value is a result of a three-axis linear interpolation approximation.

32. The graphics processing apparatus of claim 25, wherein the composite weight value corresponds to the first set of texture data and the second set of texture data.

33. The graphics processing apparatus of claim 32, wherein the composite weight value is a result of a three-axis linear interpolation.

34. The graphics processing apparatus of claim 25, further comprising means for processing fixed format data and floating point data in the first texture filter.

35. The graphics processing apparatus of claim 25, wherein the first texture filter comprises linear interpolation logic.

36. The graphics processing apparatus of claim 25, wherein the second texture filter comprises linear interpolation logic and box filtering logic.

37. The graphics processing apparatus of claim 36, where the linear interpolation logic comprises:
a multiplexer (MUX) configured to select between a plurality of inputs;
a shifter configured to receive a plurality multiplexer output values; and
an adder configured to generate a sum of a plurality of shifter outputs.

38. The graphics processing apparatus of claim 37, wherein the multiplexer receives a floor value, a ceiling value and a selection signal.

39. The graphics processing apparatus of claim 38, wherein the selection signal comprises one of a plurality of fractional value bits.

40. The graphics processing apparatus of claim 39, wherein the multiplexer selects between the floor value and the ceiling value for each of the plurality of fractional value bits.

41. The graphics processing apparatus of claim 39, wherein each of the plurality of multiplexer output values is shifted based on which of the plurality of fractional value bits provides the selection signal.

42. The graphics processing apparatus of claim 38, wherein the floor value is added to the sum of the plurality of shifter outputs.

43. The graphics processing apparatus of claim 25, wherein the accumulator comprises:
a first multiplier configured to generate a first product between the first weight value and a first fractional value;
a second multiplier configured to generate a second product between the second weight value and a second fractional value; and
an adder, configured to generate a sum of the first product and the second product.

44. A method for performing trilinear filtering is a single pass through a texture filter unit, comprising:
receiving texture data corresponding to a pixel;
interpolating a first portion of the texture data;
interpolating a second portion of the texture data;
accumulating a first weight value from the first portion and a second weight from the second portion; and
generating a composite weight value.

45. The method of claim 44, wherein the accumulating further comprises multiplying the first weight value with a first constant to generate a first product and multiplying the second weight value with a second constant to generate a second product.

46. The method of claim 45, wherein the first constant and the second constant are related values such that a sum of the first constant and the second constants equals one.

47. The method of claim 46, wherein the generating a composite weight value comprises adding the first product and the second product.

48. The method of claim 47, wherein the first constant and the second constant each correspond to a fractional component of a level of detail value.

49. The method of claim 47, wherein the composite weight value equals the first weight value.

50. The method of claim 47, wherein the composite weight value equals the second weight value.

51. The method of claim 44, wherein the interpolating the second portion of the texture data comprises:
performing nearest neighbor filtering to the texture data in a first dimension; and
interpolating the texture data in a second dimension and a third dimension.
